(19) United States
(12) Patent Application Publication
(10) Pub. No.: US 2024/0341334 A1
(43) Pub. Date: Oct. 17, 2024

(54) MEAT PRODUCTS AND METHODS FOR PRODUCING SAME

(71) Applicant: G. NOFAR FOOD AGENCIES LTD, Haifa (IS)

(72) Inventor: Gil NOFAR, Haifa (IL)

(21) Appl. No.: 18/682,819

(22) PCT Filed: Aug. 9, 2022
(86) PCT No.: PCT/IL2022/050871

§ 371 Date: Feb. 9, 2024

Related U.S. Application Data
(60) Provisional application No. 63/231,294, filed on Aug. 10, 2021.

(51) Int. Cl. A23L 13/40; A21D 2/26; A21D 8/04; A23J 3/14; A23J 3/22; A23J 3/34; A23L 13/50; A23L 13/60

(52) U.S. Cl. CPC A23L 13/426; A21D 2/264; A21D 8/042; A23J 3/14; A23J 3/227; A23J 3/346; A23L 13/424; A23L 13/428; A23L 13/52; A23L 13/62; A23L 13/65; A23L 13/67

(57) ABSTRACT

A food composition comprising meat or meat substitute, and transglutaminase-treated proteins.

### FIELD OF THE INVENTION

The invention is in the field of food technology. More particularly, the invention relates to meat products or meat-like products with improved organoleptic properties.

### BACKGROUND OF THE INVENTION

Ground meat products such as hamburger, kebab, meatballs, sausage (e.g. chorizo, merguez), chili con carne, and meat sauces for pasta are widely consumed and enjoyed. Ground meat is typically made from beef, lamb, pork, or combinations thereof. In some instances, poultry meat such as chicken or turkey is used instead of or in combination with these other meats.

In a typical ground meat product such as hamburger, much of the desirable organoleptic properties are correlated to fat percentage. Fat percentage can vary with the cut of meat used for grinding and/or the diet of the animal and/or the type of animal. Consumers typically define ground meat products with less than 20% fat as “dry tasting”, and when the fat content drops to 6 to 12%, most consumers describe the ground meat products as unpalatable.

In the US, the most common ground meat product is hamburger and the fat that imparts desirable organoleptic properties to an American hamburger is usually beef fat. A typical fast-food hamburger in the US contains 21% to 32% fat. In other places and/or other products, lamb or pork is more common and fats from those meats contribute to desirable organoleptic properties. In cases where hamburgers with 10% fat are sold, consumers respond by adding mayonnaise or other high fat sauces to combat the dry mouth feel, so that total fat intake is not reduced. It is therefore an object of the invention to provide a ground meat product with reduced fat content but with retained organoleptic properties typically associated with higher fat content.

Many popular dishes comprise ground meat steaks or whole meat steaks which are crumbed and fried. Frying thin slices of crumbed meat originated in Germany and it quickly spread to cuisines worldwide in the 19th century, the most notable dish of this type being Wiener schnitzel. While classic Wiener schnitzel comprised a pork slice, other types of meat, as well as fish, were gradually employed, including ground meat, and meat substitutes in various forms and shapes. Breadcrumb layer helps the core meat or meat substitute to keep their liquids, and it further provides a tasty crispy coat after frying. Problems arise when commercially obtained precooked products or oven-ready products are heat-treated for consumption, because the transition of the stored products from freezing to final frying or cooking, whether in oven, microwave oven or on frying pan, may result in disrupting the crumb coat or in changing its properties, sometimes leading to “mushy” character before final heating step, sometimes to weakening the adherence between the coat and core, sometimes to losing the crispiness of the final product. It is therefore another object of the invention to provide a breadcrumb coating which avoids the known drawbacks, and which will be employed for steaks of all kinds, including meat, ground meat, cultured meat, and meat substitute.

It is also an object of the invention to provide a method for improving the organoleptic and visual properties of meat products for healthy diet, the products comprising a steak of meat selected from whole meat, ground meat, cultured meat, and meat-like substitutes.

### SUMMARY OF THE INVENTION

The invention provides a food composition which comprises (a) meat or meat substitute, and (b) a processed protein ingredient mixed with transglutaminase (TG). In some preferred embodiments, said processed protein ingredient is derived from plants. In some preferred embodiments, said ingredient comprises less than 15% protein. Said meat comprises an item selected from the group consisting of beef, lamb, pork, poultry, fish, and cultured meat. Said meat substitute comprises vegetables or plant protein products. Said vegetables may comprise for example onion rings.

Said meat or said vegetable may be in the form of a slice or in a ground form. Said plant protein product may comprise crushed or otherwise processed plant part. Said plant protein product may comprise an extract from a plant part, such as from plant seeds, wherein the extraction may increase the protein content in the product relatively to said plant part, soy protein products or rice protein products serving as an example. Said processed protein ingredient is a material obtained in a process comprising at least one step modifying the consistency of the material or concentrations of its components, which for example may include a separation step, an extrusion step, or a heat-treatment step. In some preferred embodiments, said processed protein ingredient is derived from plant seeds. In some embodiments, said processed protein ingredient is derived from animal proteins, such as egg proteins or milk proteins. Said ingredient and said TG may be added to said composition also separately. In some preferred embodiments, the invention relates to a process for preparing a food composition, comprising steps of i) providing a paste of a processed protein ingredient mixed with transglutaminase, the paste containing less than 15% protein on dry basis, and ii) feeding said paste to an extruder.

In the first aspect, the invention provides a food composition comprising: (a) ground meat; (b) processed vegetable protein (PVP) comprising less than 15% protein on dry basis, said vegetable protein being treated with transglutaminase (TG); and (c) water. Said PVP is a material derived from plant in a process comprising at least one step modifying the consistency of the material or concentrations of its components, which for example may include extrusion and/or heating. Said process preferably comprises extrusion of a material obtained from crushed and optionally otherwise processed seeds. PVP for the composition according to the invention may in one preferred embodiment comprise a material called in the field “textured protein” or “textured vegetable protein” (TVP), but only if the protein content is kept under 15%; TVP is usually obtained from seeds, such as legume seeds, possibly in a process comprising defatting and/or extruding under increased temperatures. Extruding edible proteinaceous materials under increased temperatures provides puffy solids suitable for preparing various dishes or food compositions. The food composition according to the first aspect of the invention preferably comprises, within said PVP, a protein derived from plant seeds selected from the group consisting of legumes, cereals, and pseudocereals, preferred cereal being for example rice and preferred pseudocereal being for example quinoa. In some preferred embodiments, the food compositions according to the invention comprise ground meat selected from the group consisting of beef, lamb, pork, and poultry, and PVP prepared from at least one member of the group consisting of rice, quinoa, fava, peas, lentils, lupin, peanuts, beans, cereal grains, and legumes. The food composition may further comprise an additional protein that serves as a substrate for TG, for example gluten, wheat proteins, soy proteins, casein, milk proteins, albumin, egg proteins, gelatin, whereas TG may also react with proteins occurring in meat, including collagen, myosin, actin, or myoglobin. Said TG is mixed with PVP, and eventually with said additional protein, and is allowed to react for a sufficient time in accordance with the applied temperature, for example 10 hours at 4° C. or 2 hours at room temperature, after which the mixture may be extruded. The food composition according to the first aspect of the invention has a fat content of <15% on an as is basis and organoleptic properties typical for ground meat products with fat contents higher than 20%. In a preferred embodiment, the food composition of the invention comprises PVP having a protein content of <12%. The food composition of the invention loses less weight during heat treatment, and has lower shrinkage, than comparable compositions without PVP or TG; the weight loss may be lower by 10 to 50%. Said reduced weight loss is retained even if the heat treatment is preceded or followed by freezing. In some embodiments, said weight loss during heat treatment is at least twice lower when compared to products without PVP or TG; in some embodiments said weight loss is three times lower. Said weight loss may, for example, be 6% to 10% of the initial weight for the product of the invention compared with 23% to 35% weight loss for conventional products. The inclusion of PVP and TG according to the invention thus reduces product shrinkage during the dish preparation. The product of the invention thus keeps its juicy organoleptic properties, and in addition, it exhibits more stable weight and shape during its storage, and also during the final preparation steps.

The invention relates to a method of manufacturing the food composition with lowered fat content but with organoleptic properties typical for higher fat contents, the composition comprising ground meat and processed vegetable protein (PVP) treated with transglutaminase (TG), the method comprising steps of (i) treating PVP comprising less than 15% protein on dry basis with a TG solution to produce moistened enzyme treated PVP; and (ii) mixing said moistened enzyme treated PVP with ground meat to produce a PVP/meat mixture. Said method further comprises adding seasonings and/or spices. In one preferred embodiment, said method of the invention further comprises a step of adding an additional protein that serves as a substrate for TG, being selected from the group consisting of gluten, casein, albumin, gelatin, egg proteins, milk proteins, soy proteins, wheat proteins, collagen, myoglobin, myosin, and actin. Said method May comprise shock freezing said PVP/meat mixture. Said method may comprise applying a thermal treatment to said PVP/meat mixture.

In the second aspect, the invention provides a food composition comprising (a) a steak of meat or meat substitute; and (b) breadcrumbs coating said steak, wherein said breadcrumbs comprise a processed protein ingredient in mixture with transglutaminase (TG). Said steak is selected from the group consisting of beef, lamb, pork, poultry, fish, cultured meat, vegetables, and plant protein products. Said processed protein ingredient is in some embodiments selected from the group consisting of egg proteins, milk proteins, soy proteins, and wheat proteins. In some preferred embodiments, said processed protein ingredient comprises an item selected from the group consisting of soy proteins, wheat proteins, pea proteins, fava proteins, chickpea proteins, other cereal or legume proteins, and processed vegetable protein (PVP), wherein said processed protein ingredient comprises less than 15% protein (dry weight). The food composition according to the invention may further comprise an additional protein reacting with TG, for example being selected from the group consisting of egg proteins, milk proteins, soy proteins, wheat proteins, collagen, myoglobin, myosin, and actin. Said steak may comprise a slice or cut of whole material or it may comprise ground material. The food composition according to the invention is a steak coated with a breadcrumb layer, the layer exhibiting crispy character after final heat treatment, such as microwave heating after removing from freezer without thawing, and not exhibiting mushy character before said treatment, for example after unfreezing, said layer usually exhibiting good adhesion to the steak during storage and processing.

The invention also relates to a method of manufacturing steak coated with a breadcrumb layer exhibiting crispy character after final heat treatment and not exhibiting mushy character before said treatment, for example after unfreezing, said layer usually having good adhesion to the steak during storage and processing, wherein said method comprises (i) obtaining breadcrumbs containing transglutaminase (TG), and (ii) coating said steak with said breadcrumbs. Said step of coating the steak with said breadcrumbs is preferably preceded by pre-dusting said steak and dipping in a batter. Said step of obtaining breadcrumbs with TG may in one embodiment of the invention comprise (a) mixing TG with bread dough components, which may be typically selected from water, flour, salt, sugar, yeasts, baking powder, oil, and others, and leavening said dough, while allowing a sufficient time for reacting TG with proteins, (b) baking or extruding said dough to obtain bread, (c) drying said bread, and (d) grinding said bread to obtain breadcrumbs comprising TG. In another embodiment of the invention, said step of obtaining breadcrumbs with TG comprises (a) mixing TG with dough components to obtain a dough mixture, wherein said dough components may comprise any type of flour or vegetable powder or other vegetable components, such as comprising potatoes, eventually partially dried, while allowing a sufficient time for reacting TG with proteins, (b) extruding or baking said dough mixture to obtain extruded or baked bodies, (c) drying said bodies, and (d) grinding said dried bodies to obtain breadcrumbs comprising TG. In a still another embodiment of the invention, said step of obtaining breadcrumbs with TG comprises (a) providing breadcrumbs of any type, possibly comprising regular bread components or any vegetable components, such as potatoes, and mixing them with TG, and water to obtain wet crumbs, and (b) drying said crumbs to obtain active breadcrumbs or a breadcrumb-like material. In all embodiments, TG is allowed to sufficiently react with proteins present in the mixture before heating or drying. In some embodiments, the method of the invention comprises adding to said breadcrumbs or to said dough an additional protein which serves as a substrate for TG, being selected from the group consisting of egg proteins, milk proteins, soy proteins, wheat proteins, collagen, myoglobin, myosin, and actin. In a preferred embodiment, the method of the invention comprises adding to said breadcrumbs or to said dough albumin, and TG is allowed to sufficiently react, for example during leavening, with albumin and other proteins present in the mixture before heating (baking or extruding) or drying, eventually comprising baking or extruding. Thus, the breadcrumbs with TG employed in the invention comprise classic breadcrumbs in some embodiments, but they may comprise also crumbs obtained from other types of doughs or mixtures, including various vegetable components such as potatoes, wherein the final structure is breadcrumb-like, namely if the breadcrumbs comprise beside TG and proteins serving as a substrate for TG also plant components like starch, and wherein the breadcrumbs or breadcrumb-like materials usually comprise at least 50% mass having a size between 0.1 and 3.5 mm. Said step of coating the steak with said breadcrumbs or breadcrumb-like material is preferably preceded by pre-dusting said steak and dipping in a batter.

In some preferred embodiments, the invention relates to a food composition comprising an extruded proteinaceous puffy solid and transglutaminase. Said puffy solid preferably comprises less than 15% protein on dry basis. In a preferred embodiment, the invention provides a food composition comprising a steak containing an extruded proteinaceous puffy solid and transglutaminase.

A broad aspect of the invention relates to low fat ground meat products. The first aspect of the invention relates in some embodiments to inclusion of processed vegetable protein (PVP), such as textured vegetable protein (TVP), pre-soaked in water, into ground meat. According to various exemplary embodiments of the invention the PVP is derived from rice, quinoa, soybean, lentils, bean, pea, cottonseed, wheat, oats, corn, or other beans or grains. Alternatively or additionally, in some embodiments the PVP has a protein content, on dry basis, of at least 2%, at least 3%, at least 7%, at least 8%, at least 9%, at least 10%, at least 11%, at least 12%, at least 13%, at least 14% or intermediate on a dry matter basis. Alternatively or additionally, in some embodiments the PVP has a protein content on dry basis of less than 15%, less than 14%, less than 13%, less than 12%, less than 11%, less than 10%, less than 9%, less than 8%, less than 7%, less than 4%, on a dry matter basis. In some exemplary embodiments of the invention, the PVP is ground to 0.3 mm to 6 mm particles prior to soaking or after soaking. In many cases, these particle sizes result from the original production process. Alternatively or additionally, in some embodiments these particle sizes contribute to emulation of the organoleptic properties of fat particles in ground meat. According to various exemplary embodiments of the invention, the PVP:water ratio for soaking is 1:2 or 1:3 or 1:4 or 1:5. One example of a rice based PVP are dehydrated rice flakes containing about 68% carbohydrates, 8% protein, 2% fat, 11% fiber (for example Dehydrated rice flake fine of Meatless Company). One example of a quinoa based PVP are dehydrated quinoa flakes containing 67% carbohydrates, 11% protein; 6% fat, and 6% fiber (for example Dehydrated quinoa flake fine of Meatless company). In some cases, PVP materials are obtained dried or in hydrated states with various amounts of water, possibly frozen, sometimes also comprising additional edible non-proteinaceous materials such as polysaccharides like alginates. Another aspect of some embodiments of the invention relates to enzyme treatment of PVP, such as PVP by transglutaminase (e.g. BDF PROBIND TXo or similar). Percentages are W/W (weight per weight) unless otherwise indicated. Percentages of components of a product are on a dry matter basis by weight unless otherwise indicated. In some embodiments, commercial vegetable protein products are employed as PVP, said products occasionally being hydrated and/or frozen; TG and eventually additional proteins may be added to said products without adding water and soaking if they are sufficiently hydrated.

An interesting aspect of some embodiments of the invention relates to relying on water to provide organoleptic properties typically associated with fat to a ground meat product. It will be appreciated that the various aspects described above relate to solution of technical problems reducing fat content while retaining desirable organoleptic properties in a ground meat product. Alternatively or additionally, it will be appreciated that the various aspects described above relate to solution of technical problems related to reducing the incidence of short-term adverse effects such as heartburn typically associated with consumption of ground meat. Alternatively or additionally, it will be appreciated that the various aspects described above relate to solution of technical problems related to reducing the incidence of long-term adverse effects such as high cholesterol and/or atherosclerosis typically associated with consumption of ground meat over the course of time. Various aspects of the invention thus contribute to providing meat products for healthier diet.

In some exemplary embodiments of the invention there is provided a food composition including: ground meat, processed vegetable protein (PVP) treated with transglutaminase, and water. In some embodiments, the composition includes at least one member of the group consisting of flavoring agents and seasonings. Alternatively or additionally, in some embodiments the composition includes albumin or soy protein or egg-derived products or collagen or any protein that serves as a substrate for transglutaminase. Alternatively or additionally, in some embodiments the ground meat includes at least one member of the group consisting of beef, lamb, pork, and poultry. Alternatively or additionally, in some embodiments the PVP is prepared from at least one member of the group consisting of rice, quinoa, fava, peas, lentils, lupin, peanuts, beans, cereal grains, and legumes. Alternatively or additionally, in some embodiments the composition has a fat content of ≤2%; ≤3%; <4%; ≤5%; <6%; <7%; <8%; or ≤15%; on an as is basis. Alternatively or additionally, in some embodiments the composition has a protein content ≤25% or ≤20% on an as is basis.

In some exemplary embodiments of the invention there is provided a method including: treating processed vegetable protein (PVP) with a transglutaminase (TG) solution to produce moistened enzyme treated PVP; and mixing the moistened enzyme treated PVP with ground meat to produce a PVP/meat mixture. In some embodiments, the method includes adding seasonings and/or spices. In some embodiments the method includes adding other proteins serving as substrate for TG, such as collagen, milk proteins or others. In a preferred embodiment, at least one member of the group consisting of albumin and soy protein is added to said meat. Alternatively or additionally, in some embodiments the PVP/meat mixture has a fat content of <2%; <3%; ≤4%; <4%; ≤6%; <7%; <8%; or <15%; on an as is basis. Alternatively or additionally, in some embodiments the ground meat includes at least one member of the group consisting of beef, lamb, pork, and poultry. Alternatively or additionally, in some embodiments the PVP is prepared from at least one member of the group consisting of rice, beans, cereal grains, and quinoa. Alternatively or additionally, in some embodiments the method includes shock freezing the PVP/meat mixture. Alternatively or additionally, in some embodiments the method includes applying a thermal treatment to said PVP/meat mixture.

New studies link a high meat diet to more diseases than previously thought, including heart diseases, diabetes, gastrointestinal diseases, and pneumonia, among others. As the present invention in one aspect aims at providing meat products and meat-like products with lower fat content, and in another aspect it aims at providing food products substituting meat with vegetables, the invention provides a wide variety of new products to the market of healthy diet.

### BRIEF DESCRIPTION OF THE DRAWINGS

In order to understand the invention and to see how it may be carried out in practice, embodiments will now be described, by way of non-limiting examples only, with reference to the accompanying figures. The attached figures are:

FIG. 1 is a photograph of three hamburgers (no PVP; PVP 3 mm, and PVP>3 mm) in a skillet prior to cooking;

FIG. 2 is a photograph of the three hamburgers of FIG. 1 during cooking;

FIG. 3 is a photograph of the three hamburgers of FIG. 1 at the end of cooking;

FIG. 4 is a pair of photographs of rice PVP soaked in water (left side no enzyme; right side transglutaminase treated according to an exemplary embodiment of the invention) before squeezing;

FIG. 5 is a pair of photographs of rice PVP soaked in water only (left side) or water+transglutaminase (right side) after squeezing with 20 kg pressure in an ILLY coffee tamper;

FIG. 6 is a pair of photographs of kebab according to an exemplary embodiment of the invention cooked then frozen (left side) and frozen without cooking (right side); and

FIG. 7 is a pair of photographs of hamburgers according to an exemplary embodiment of the invention frozen without cooking (left side) and cooked then frozen (right side).

### DETAILED DESCRIPTION OF EMBODIMENTS

Edible protein ingredients are appreciated not only for their nutritive value in food products, but also for their ability to affect the structure of the products and their organoleptic features. If not stated otherwise, the protein ingredients may comprise proteins of plant origin (for example comprising plant seeds) including cereals and legumes for the purpose of the invention. Said protein ingredients are admixed with transglutaminase for use in improving the organoleptic properties of meat products or meat-like products in accordance with the invention. In the context of the invention, the meat-like products are either food products imitating meat, such as meat substitutes (for example tofu or textured vegetable protein), or vegetable products (such as onion rings) cooked in a way typical for meat meals, such as ground vegetable balls or fried vegetable schnitzel. The meat-like products aim at qualities typical for meat, such as mouthfeel, flavor, consistence, and appearance. A first aspect of the invention relates to food compositions comprising ground meat, and a vegetable protein ingredient with transglutaminase admixed in said meat. A second aspect of the invention relates to food compositions comprising a coated meat steak, and a processed protein ingredient with transglutaminase in crumbs which coat said steak, the crumbs being classic breadcrumbs or any breadcrumb-like materials comprising dough components or other starch-comprising components.

Some embodiments of the invention relate to low fat ground meat products and methods of producing them. Specifically, some embodiments of the invention can be used to reduce the fat percentage in a ground meat product while retaining organoleptic properties associated with a higher fat version of a similar product. The principles and operation of ground meat products and/or production methods according to exemplary embodiments of the invention may be better understood with reference to the drawings and accompanying descriptions.

### Exemplary Compositions

Some exemplary embodiments of the invention relate to a food composition including ground meat, a processed vegetable protein (PVP) treated with transglutaminase, and water. In some exemplary embodiments of the invention, cuts of meat with a low-fat percentage (e.g. less than 10% or less than 5%) are selected and/or prepared by trimming fat prior to grinding. In some exemplary embodiments of the invention, the composition includes flavoring agents and/or seasonings and/or spices. Alternatively or additionally, in some embodiments the composition includes albumin or another protein that reacts with transglutaminase (e.g. soy protein). According to various exemplary embodiments of the invention, the ground meat includes beef and/or lamb and/or pork and/or poultry. Alternatively or additionally, according to various exemplary embodiments of the invention the PVP is prepared from rice and/or quinoa and/or beans (e.g. soybeans or fava beans) and/or a cereal grain (e.g. wheat) and/or legumes (e.g. peas, lentils, lupin or peanuts). In some exemplary embodiments of the invention, the ground meat/PVP composition has a fat content of ≤15%; <12%; ≤10%; <8%; <6%; <4%; <3%; <2% or lower or intermediate percentages on an as is basis. Alternatively or additionally, in some embodiments of the invention the PVP has a protein content of <20%; <15%; <12%; <10%; <8%; ≤6%; <4; ≤3%; <2% or intermediate percentages on dry matter basis.

### Exemplary Methods

Some exemplary embodiments of the invention relate to a method including treating a processed vegetable protein (PVP), such as low-protein TVP-like materials, with a transglutaminase solution to produce moistened enzyme treated PVP and mixing the moistened enzyme treated PVP with ground meat to produce a PVP/meat mixture. In some exemplary embodiments of the invention, the method includes adding seasonings and/or spices or/flavors. Alternatively or additionally, in some embodiments the method includes adding albumin or another protein that reacts with transglutaminase to the meat. In some exemplary embodiments of the invention, the PVP/meat mixture has a fat content of ≤2-10% or 2% to 20% on an as is basis. In some embodiments, the method includes shock freezing the treated PVP/meat mixture. Alternatively or additionally, in some embodiments the method includes thermal treatment of the treated PVP/meat mixture.

### Exemplary Preparation of PVP Component

Table 1 illustrates amounts of ingredients for preparation of enzyme treated PVP, such as for example vegetable products of Meatless Company. Transglutaminase enzyme was mixed in water (2° C.-25° C.) in a high-speed mixer until dissolved (2 seconds to 2 minutes) and the resultant enzyme solution was mixed with PVP until the PVP was thoroughly moistened. The moistened PVP/enzyme mixture was placed in a refrigerator (+4° C.) for 6 hours. During this time, most or all of water was absorbed. An additional 250 grams of water was added to the Quinoa PVP enzyme mixture. Only 100 g additional water was needed for rice based PVP. Both rice and quinoa based PVP were refrigerated (+4° C.) for an additional time of 14 hours (20 hours total). PVP prepared in a similar manner without enzyme did not bind well to meat, was soften texture, and separated from the meat in a frying pan. After the initial preparation experiment, all of water (both aliquots) was added at the beginning with the enzyme with no perceptible change in the final product. Regardless of the schedule for adding the water, excess water is removed by draining and gently squeezing the enzyme treated PVP.

TABLE 1
Exemplary enzyme treatment of PVP

| Ingredient | Rice based PVP* | Quinoa based PVP** |
|---|---|---|
| PVP (dry basis) (g) | 100 | 100 |
| Water (g) | 200 | 200 |
| Transglutaminase (g) | 3 | 3 |
| Water (g) 2^{nd} aliquot | 100 | 250 |

*MEATLESS Dehydrated rice flake fine
**MEATLESS Dehydrated quinoa flake

The enzyme treated PVP with absorbed water was then mixed with ground meat as detailed herein below. In some exemplary embodiments of the invention, an additional protein solution is added to the PVP before or after or during incubation with the transglutaminase enzyme. In some exemplary embodiments of the invention, the additional protein solution contains albumin, powdered soy protein or other protein that serves as a substrate for transglutaminase. In some embodiments, the total amount of additional protein in the solution is usually 5% of the amount of PVP or more on dry basis (e.g., 60 g additional protein in solution to 200 g PVP) or more.

### Effect of Enzyme Amount on Product Texture

According to various exemplary embodiments of the invention, the amount of transglutaminase enzyme is varied from 0.005% to 6.0% of the total weight of meat, PVP and water. In some exemplary embodiments of the invention, an increase in the amount of enzyme contributes to an ability of the enzyme treated PVP to bind the meat.

The first aspect of the invention employs, in one embodiment, the enzyme treated PVP in mixtures with ground meat, for example as follows. Table 2 illustrates amounts of ingredients for preparation meat mixtures containing enzyme treated PVP. Transglutaminase treated rice based PVP was prepared as described above and refrigerated for a total of 20 hours.

TABLE 2
Exemplary meat products with enzyme treatment of PVP

| Ingredient (g) | *Hamburger | *Kebab | *Merguez | †Poultry |
|---|---|---|---|---|
| Ground Meat | 446 | 446 | 446 | 446 |
| INNOVA tallow flavor | 1.1 | 1.1 | 1.1 | 1.1 |
| INNOVA beef flavor | 1.1 | 1.1 | 1.1 | 1.1 |
| BASIC FOOD beef | 4.0 | 4.0 | 4.0 | 4.0 |
| flavor yeast | | | | |
| Bicarbonate of soda | 3.0 | 3.0 | 2.0 | 3.0 |
| Salt | 3.0 | 3.0 | 3.0 | 3.0 |
| Sweet paprika | 3.5 | 3.5 | 3.5 | 3.5 |
| Powdered black pepper | 1.8 | 1.8 | — | 1.8 |
| Spice GIL | — | — | 16 | — |
| **Albumin solution | — | — | 14 | — |
| ‡Albumin solution 2 | — | — | — | 20-30 |
| | | | | As needed |
| Enz. Treated PVP | 220 | 220 | 220 | 220 |
| Chopped parsley | — | 16 | | |
| Frozen onion chips | — | 65 | | |

*Beef: 297 (g) neck (number 10)/149 (g) rib cover (number 7).
**Albumin solution: 14 g albumin in 20 g water mixed at high speed in a blender until a thick solution forms.
†Poultry: 297 (g) chicken breast/149 (g) turkey breast.
‡Albumin solution 2: 20 g albumin in 20 g water mixed at high speed in a blender until a thick solution forms.

For hamburger, lean Paraguayan beef (<5% fat) was ground at −5° C. using a 4 mm screen. Dry spice and seasoning ingredients were mixed and kneaded into the ground meat until a sticky feeling was achieved indicating release of actin and myosin. This was verified by rolling the meat to form a cylinder with a length of 12 cm with a diameter of 1.5 cm. If the cylinder can be lifted by one end without breaking, the proteins are sufficiently released. The right consistence of the mixture may also be assessed according to the resistance offered to the mixing machine as measured by its electric input. The 220 g of lightly squeezed enzyme treated PVP was then added and mixed to achieve uniform consistency. The meat/PVP mixture was formed into patties. No mushiness was observed due to the presence of the PVP.

For kebab, the process was similar except that parsley and frozen onion chips were added after the PVP. For merguez, the process was similar except that the spice and seasoning ingredients are slightly different (see table 2) and an albumin solution as indicated in table 2 was prepared and added to the meat/spice/seasoning mixture optionally prior to mixing with the PVP. In this case, the meat/PVP mixture was packed into sausage casings. For the poultry product, frozen chicken and turkey were used. The frozen meat was thawed and ground with a 4 mm screen. In other exemplary embodiments of the invention, fresh poultry meat is employed to prevent cell disruption that can have an adverse effect on the final product. The procedure is similar to that for merguez except that the spices/seasonings are slightly different, and the albumin solution is slightly different (see table 2). When using poultry meat, it is important to avoid over-kneading at the beginning of the process.

All of the products had a final fat concentration of 2% to 3% on an “as is” basis. Despite low fat content, human tasters described the products as juicy and compared them favorably with higher fat conventional products. In some embodiments, the transglutaminase treatment of the PVP contributes to the perceived juiciness and “fatness” of the final product and/or of the meat itself, said positive organoleptic features being in some cases accentuated by increased moisture of said PVP.

### Exemplary Pre-Freezing of Enzyme Treated PVP

The enzyme treated PVP can be prepared as described hereinabove and frozen. In some embodiments, the freezing is shock freezing as described hereinabove. The frozen product can then be thawed and used as described hereinabove. In some embodiments, particles of moist enzyme treated PVP are distributed as separated particles on a conveyor belt that runs through a freezer to freeze them. In some embodiments, these frozen particles are added to a meat mixer without disintegration or breaking as a result of the mixing process.

Lean cuts of beef, optionally trimmed to further reduce fat, are used in many embodiments of the invention. For example, Israeli cuts nos. 2, 3, 4, 6, and 10 (neck, brisket, shoulder, ribs, and false filet). In some embodiments, a low sodium salt substitute and/or fungal salt substitute is used for seasoning. In some embodiments, sodium reduction contributes to an increase in health value of the final product.

### Additional Exemplary Preparation of PVP Component

Tables 3A and 3B illustrate amounts of ingredients for preparation of enzyme treated PVP from rice. Transglutaminase enzyme was mixed in water (2° C.-25° C.) until fully dissolved (about 2 minutes in a high-speed mixer), and the resultant enzyme solution was mixed with PVP until the PVP was thoroughly moistened. The moistened PVP/enzyme mixture was placed in a refrigerator for 20 hours (turkey trial, table 5) and 15 hours (beef trial, table 4). During this time, most or all of water was absorbed. No additional water was needed for rice based PVP. Albumin is included in some embodiments.

TABLE 3A
Exemplary enzyme treatment of PVP from rice

| | Rice based PVP* | Rice based PVP* |
|---|---|---|
| Ingredient | (fine 2-3 mm~) | (fine 2-3 mm~) |
| PVP (dry basis) (g) | 200 | 220 |
| Water (g) | 800 | 880 |
| Transglutaminase (g) | 9 | 10 |
| Total product after draining | 646 g | ~700 g |

*MEATLESS Dehydrated rice flake fine

TABLE 3B
Exemplary enzyme + albumin treatment of PVP from rice

| | Rice based PVP* | Rice based PVP* |
|---|---|---|
| Ingredient | (fine 2-3 mm~) | (fine 2-3 mm~) |
| PVP (dry basis) (g) | 350 | 350 |
| Water (g) | 1400 | 1400 |
| Transglutaminase (gr) | 16 | 16 |
| Albumin (gr) | 87.6 | |
| Total product after draining | 1030 g | ~940 g |

*MEATLESS Dehydrated rice flake fine

The enzyme treated PVP with absorbed water, after removing water excess by draining and gently squeezing said treated PVP, was then mixed with ground meat as detailed herein below.

Exemplary Preparation of PVP/Ground Meat Mixtures in Accordance with the First Aspect of the Invention

The moistened PVP/enzyme mixture as described in Table 3A above was placed in a refrigerator for 20 hours for chicken and turkey, and 15 hours for beef. There was no difference in the product by weight and hardness. During this time, most or all of water was absorbed. Preliminary results suggest that incubation time in the refrigerator can be reduced to 4 to 5 hours.

TABLE 4
Exemplary enzyme treatment of PVP beef

| Ingredient (g) | *Hamburger | *Kebab | *Merguez |
|---|---|---|---|
| Ground Meat Neck (10) | 446 | 446 | 446 |
| 297 g and cover (7) 149 g | | | |
| INNOVA tallow flavor | 0.9 | 0.9 | 0.9 |
| INNOVA beef flavor | 0.8 | 0.8 | 0.8 |
| BASIC FOOD beef flavor | 6.5 | 6.67 | 7.5 |
| yeast YE15 | | | |
| Bicarbonate of soda | 1.0 | 1.5 | 0.0 |
| Salt | 3.0 | 2.66 | 2.66 |
| Sweet paprika | 3.3 | 3.3 | 2.5 |
| Powdered black pepper | 1.0 | 1.0 | — |
| Spice GIL | 6 | 7.7 | 16.66 |
| **Albumin solution | — | — | 31.33 |
| Enz. Treated PVP | 220 | 220 | 220 |
| Chopped frozen parsley | — | 16 | |
| Frozen onion chips | — | 65 | |

*Beef: 297 (g) neck/149 (g) rib cover, meat was partly still frozen during the grinding process.
**Albumin solution: 15.66 g albumin in 15.66 g water mixed at high speed in a blender until a thick solution forms.

TABLE 5
Exemplary enzyme treatment of PVP poultry

| Ingredient (g) | *Hamburger | *Kebab | *Merguez |
|---|---|---|---|
| Ground Poultry chicken | 446 | 446 | 446 |
| breast 297 g and turkey | | | |
| breast 149 g | | | |
| BASIC FOOD Smokey | 5.5 | 5.5 | 8.5 |
| flavor yeast YE | | | |
| Bicarbonate of soda | 5.0 | 5.0 | 0.0 |
| Salt | 3.5 | 3.5 | 2.66 |
| Sweet paprika | 3.5 | 3.5 | 3.5 |
| Powdered black pepper | 1.0 | 1.0 | — |
| Spices GIL | 5.0 | 5.0 | 16.0 |
| **Albumin solution | — | — | 28.0 |
| Enz. Treated PVP | 220 | 220 | 220 |
| Chopped frozen parsley | — | 16 | |
| Frozen onion chips | — | 65 | |

**Albumin solution: 14.0 g albumin in 14.0 g water mixed at high speed in a blender until a thick solution forms.
*Poultry: 297 (g) fresh chicken breast/149 (g) turkey breast

The experiments comprised in Tables 4 and 5 were repeated with different PVP samples as described in Tables 3, with or without albumin, as well as with/without adding bicarbonate. The presence of albumin led to better integration of PVP with ground meat both before and after heat treatment, and the sensory analysis of the final meat product showed stronger and more compact feeing during biting the meat product comprising albumin. The experiments in accordance with Tables 3 and 5, comprising poultry or beef and performed without bicarbonate provided better texture.

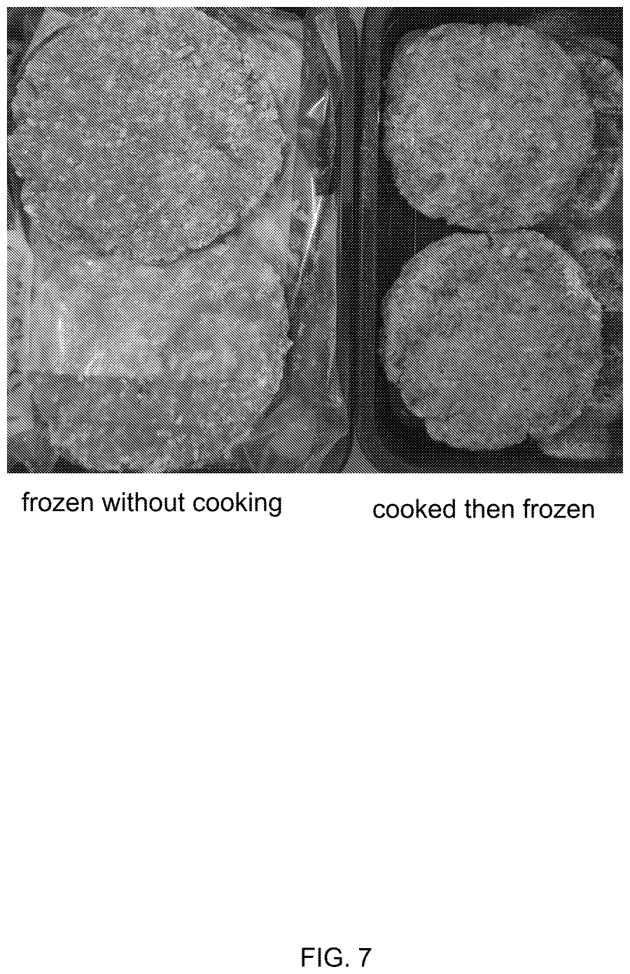

For beef (table 4): Hamburger, lean Paraguayan beef (<5% fat) was ground at −5° C. using a 4 mm screen. Dry spice and seasoning ingredients were mixed and kneaded into the ground meat until a moderate sticky feeling was achieved indicating release of actin and myosin. This was verified by rolling the meat to form a cylinder with a length of 12 cm with a diameter of 1.5 cm. If the cylinder can be lifted by one end without braking, the proteins are sufficiently released. The 220 g of enzyme treated PVP was gently squeezed to remove excess water (before adding to the meat) and mixed with the meat to achieve uniform consistency. The meat/PVP mixture was formed into patties. No mushiness was observed due to the presence of the PVP. FIG. 7 is a pair of photographs of hamburgers prepared this way frozen without cooking (left side) and cooked then frozen (right side). Average shrinkage during cooking was 6% to 8% by weight.

For kebab, the process was similar except that parsley and frozen onion chips were added after the PVP. For merguez, the process was similar except that the spice and seasoning ingredients are slightly different (see table 4) and an albumin solution as indicated in table 4 was prepared and added to the meat/spice/seasoning mixture prior to mixing with the PVP. In this case, the meat/PVP mixture was packed into sausage casings.

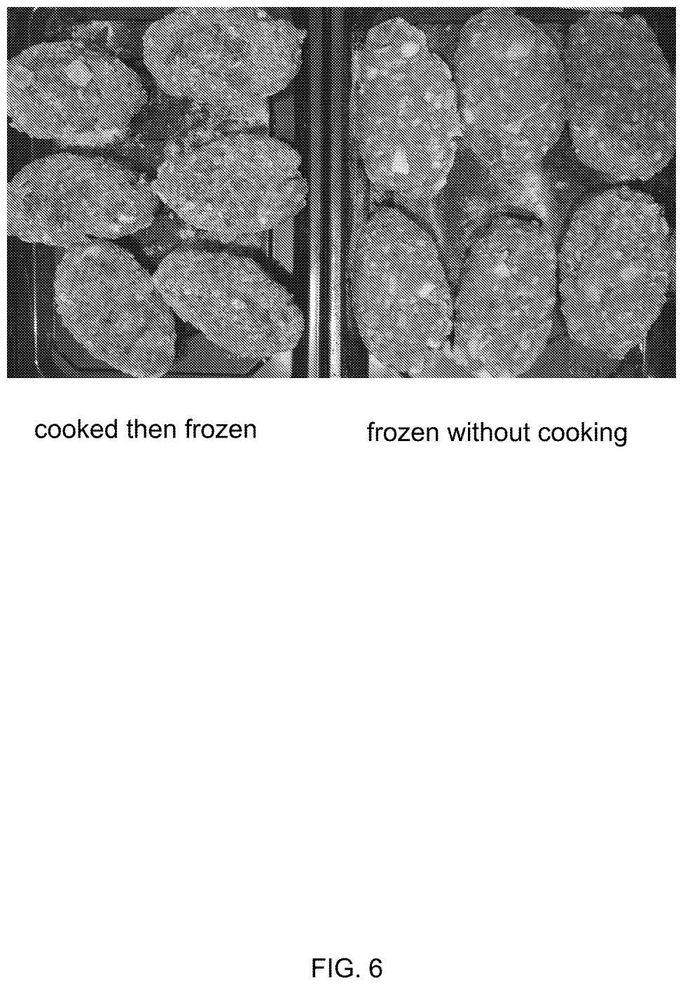

FIG. 6 is a pair of photographs of kebab prepared this way then cooked and frozen (left side) and frozen without cooking (right side).

For the poultry product (table 5), fresh chicken and turkey was ground at 2° C. to 4° C. using an 8 mm screen. Use of fresh meat prevents cell disruption that can have an adverse effect on the final product. If frozen poultry meat is used, it must be squeezed to remove water. The procedure is similar to that for merguez except that the spices/seasonings are slightly different and the albumin solution is slightly different (see table 5). When using poultry meat, it is important to avoid over-kneading at the beginning of the process. Sodium bicarbonate may be included or omitted.

All of the products had a final fat concentration of 2% to 3% on as is basis. The enzyme and/or the water absorbed in the PVP and/or the added proteins appear to contribute to a sensation of increased juiciness. In some embodiments, the increased juiciness is perceived by human tasters as evocative of a high fat product.

These products were subject to shock freezing and/or thermal treatment as described above. The final shock freezing contributes to a reduction in cell disruption. It is believed that cell disruption in a mixed meat/PVP product contributes to undesirable organoleptic properties.

### Effect of Albumin

Where albumin is indicated as an ingredient above, it is optional. In some embodiments, albumin contributes to the texture and/or strength of the final product.

### Exemplary Enzyme Considerations

In some exemplary embodiments of the invention, a cool temperature (˜3° to 5° C. or more) contributes to the effect of the enzyme on the PVP. At these temperatures, a reaction time of 8 to 24 hours is used according to various embodiments of the invention. Transglutaminase does not cross-link between fat tissues. Therefore, a low fat or no fat PVP is used in many embodiments of the invention in conjunction with lean cuts of meat or poultry.

Phosphates and other salts are added in some embodiments, not only to enhance the organoleptic properties of the final product, but also to solubilize the proteins and make them more available for the enzymatic effect before transglutaminase is applied to the substrate. When the meat/PVP mixture is refrigerated, the transglutaminase continues to work. Transglutaminase is usually inactive below 2° C. but is active at normal refrigeration temperatures. The enzymatic activity contributes to a reduction in separation of the pieces of the fat replacement (PVP+water) from the meat. The enzyme adheres the PVP pieces to the meat and so they will not separate from the meat while frying/cooking and cutting. The enzyme reaction contributes to an improvement in the final texture of products and/or the mouth feel. Alternatively or additionally, in some embodiments the transglutaminase reacts with collagen, myoglobin, myosin, and actin in the meat to increase intramolecular adhesion. This adhesion, once established is not reversed by cooking. Alternatively or additionally, in some embodiments thiols adhesion contributes to a reduction in moisture loss during cooking.

In some exemplary embodiments of the invention, the raw meat/PVP mixture is cooked in two phases. The first phase includes cooking the mixture at a temperature of 40° C. to 50° C. for about 120 seconds or more. This first phase allows the transglutaminase to remain active. The second phase increases the temperature to the desired cooking temperature and the mixture is fully or partially cooked. In this second stage, the transglutaminase enzyme is inactivated.

In some embodiments, after the first phase or the second phase the mixture is frozen. In some embodiments, freezing after the second phase contributes to an increase in shelf life. In some embodiments, the increased shelf life makes the frozen product amenable to long distance shipping, and eventually selling the product overseas. According to various exemplary embodiments of the invention, fresh meat may be frozen, unfrozen and cooked, or alternatively cooked for thermal treatment and frozen; the final consumer may perform the final cooking either with or without previous thawing.

### Exemplary Fresh Freezing

The ground meat PVP mixtures described above can be marketed raw (without thermal treatment) after shock freezing at −40° C. to −35° C. and wrapping. In some embodiments, these products lost 6% to 10% of their size and weight when pan-fried and frozen, compared to 22% to 35% shrinkage for conventional products after cooking, the loss increasing with increased time of cooking. Fresh frozen products without heat treatment are expected to have a shelf life of 60 days in the freezer. The cooked product retains “fatty” or “juicy” organoleptic properties, which impart a mouth feel of a much higher fat product. In some embodiments, these fresh frozen products can be “fried” in a non-stick pan with no oil, in a regular frying pan with an amount of oil or on a barbecue grill or in oven or in toaster. The hamburger, kebab, merguez, and ground poultry product can all be formed into the desired shapes, optionally shock frozen then thawed for thermal treatment (e.g., in a frying pan or on a barbecue grill) then shock frozen again or alternatively cooked for thermal treatment and frozen. This process gives the products a shelf life of over a year (in the freezer).

Alternatively, the hamburger, kebab, merguez, and ground poultry product can all be formed into the desired shapes, be frozen and after thawingbe subjected to thermal treatment (e.g., in a frying pan or barbecue grill or oven or infra-red oven), or alternatively be subjected to thermal treatment without previous freezing and thawing, and then shock frozen. This process also gives the products a shelf life of over a year (in the freezer).

### Shear Strength Test

An ILLY coffee tamper (from the coffee compartment of an espresso machine) provides 20 kg of compaction from a single activation. Enzyme treated PVP as in Table 1 remained intact and solid under these conditions. Untreated PVP (soaked in water without enzyme) was compressed and crumbled under these conditions.

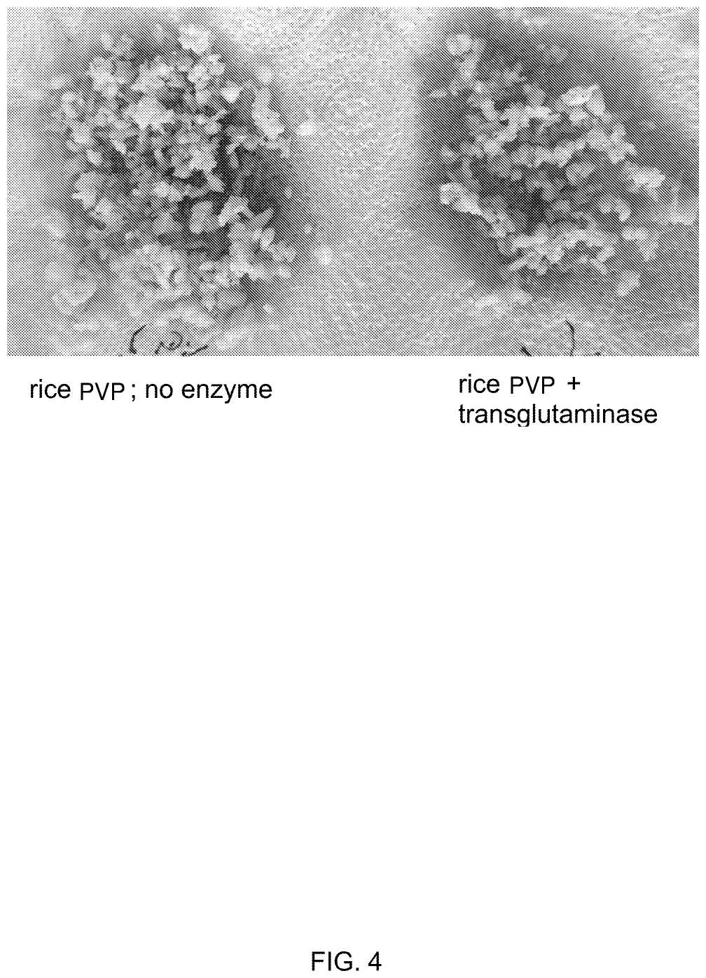

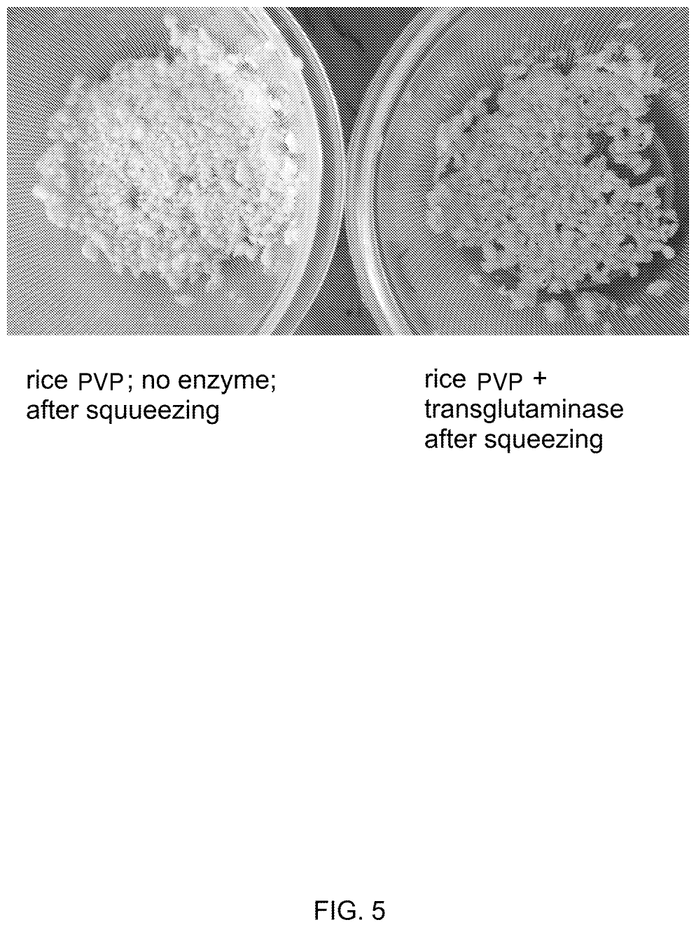

FIG. 4 is a pair of photographs of rice PVP soaked in water (left side no enzyme; right side transglutaminase treated according to an exemplary embodiment of the invention) before squeezing. FIG. 5 is a pair of photographs of rice PVP soaked in water only (left side) or water+transglutaminase (right side) after squeezing with 20 kg pressure in an ILLY coffee tamper. Rice PVP that was not enzyme treated appeared mushy and released more water in response to squeezing than PVP treated with transglutaminase as seen in the photos. One possible explanation for this observation is that the enzyme treatment hardens the PVP so that it releases less water in response to an applied force.

### Exemplary Thermal Treatment

The fresh hamburger, kebab, merguez, and ground poultry product were each subjected to thermal treatment on a griddle (with raised stripes) or grill rack with a heart source below to sear them and provide grill marks as with conventional meat products. In some embodiments, these products lost 6% to 10% of their size and weight as a result of thermal treatment, compared to 23% to 35% weight loss for conventional products. Similar results were achieved with products that were shock frozen prior to thermal treatment.

After thermal treatment, the products can be shock frozen and wrapped as described above. The shelf life after thermal treatment and shock freezing is over one year. Thermally treated products are typically eligible for veterinary certification to make them export eligible.

### Enzyme Effect and Behavior During Process and Cooking

Thermally treated products as described above can be thawed and cooked with little or no additional loss in weight or volume. The cooked product retains its “juicy” organoleptic properties, which impart a mouth feel of a much higher fat product.

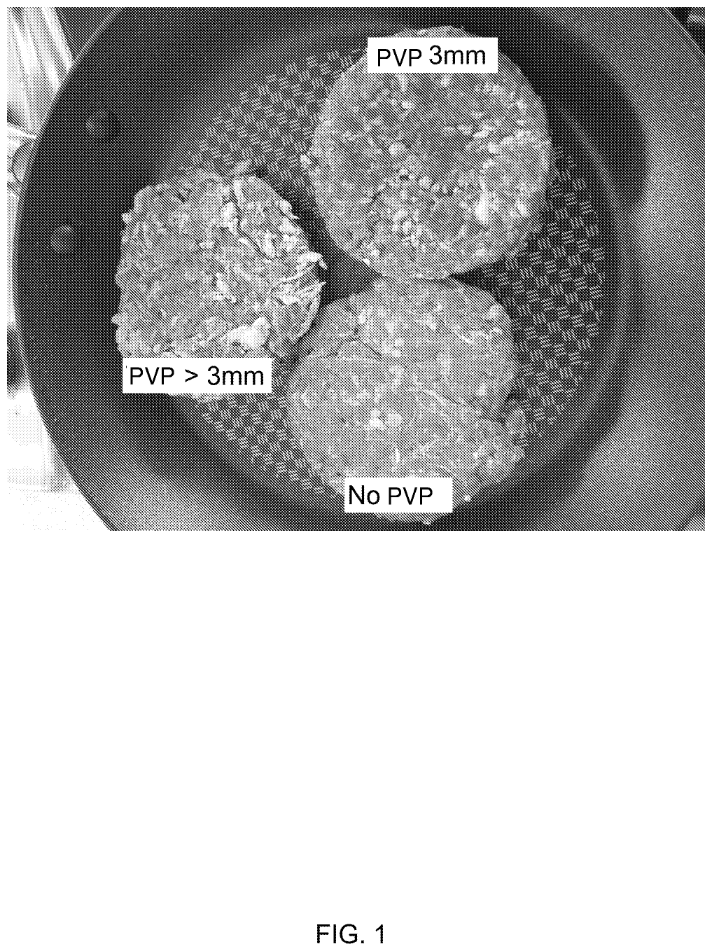

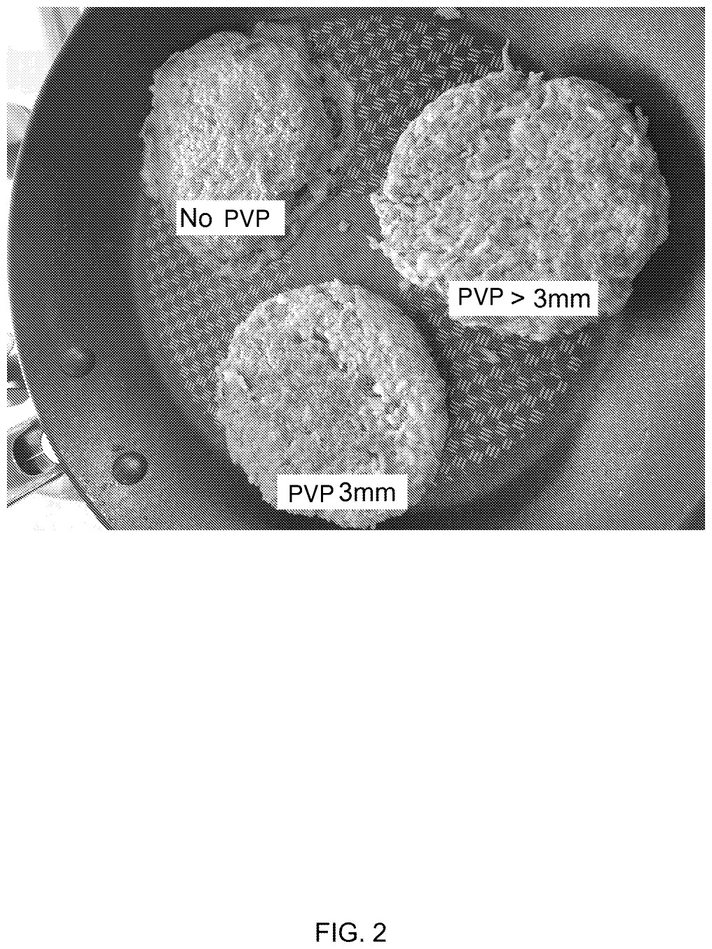

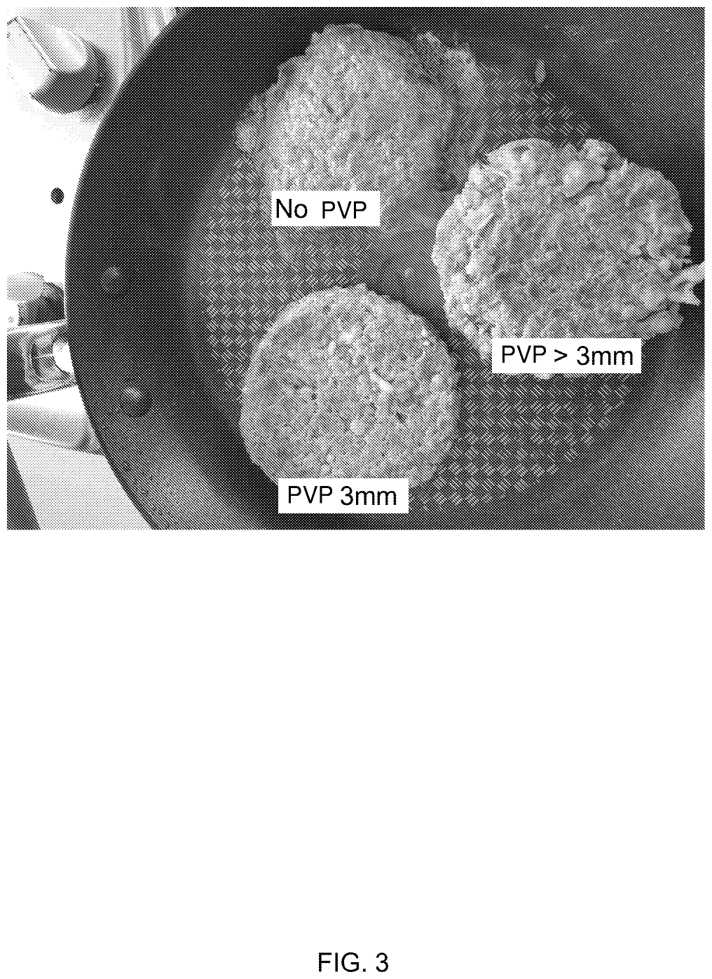

FIG. 1 is a photograph of three hamburgers (no PVP, PVP 3 mm, and PVP>3 mm) in a skillet prior to cooking. FIG. 2 is a photograph of the three hamburgers of FIG. 1 during cooking. FIG. 3 is a photograph of the three hamburgers of FIG. 1 at the end of cooking. These three figures illustrate that the hamburgers containing PVP according to an exemplary embodiment of the invention shrink less than a hamburger prepared from the same meat but with no PVP. In addition, the hamburgers containing PVP according to an exemplary embodiment of the invention release virtually no smoke during cooking, in sharp contrast to a comparable hamburger prepared with no PVP. In addition, the hamburgers containing PVP according to an exemplary embodiment of the invention release virtually no liquids during cooking. In sharp contrast to a comparable hamburger prepared with no PVP.

Specifically, the first aspect of the invention has been described in the context of hamburger, kebab, merguez, ground beef, and ground poultry but might also be used in a wide variety of other ground meat products and/or cold cuts, as well as in a variety of meat substitutes and vegetables.

### Exemplary Advantages of the First Aspect of the Invention

In some exemplary embodiments of the invention, a ground meat/PVP composition according to an exemplary embodiment of the invention has a fat content of 2%-3% fat but gives the mouth feel of an all meat-product with 15%-30% fat.

Substitution of these low-fat compositions for higher fat all meat compositions in a wide range of product has the potential to reduce average fat intake in the population without decreasing consumer acceptance. Decreasing average fat intake has the potential to contribute to a reduction in the incidence of a wide variety of health problems.

### The Second Aspect of the Invention

The second aspect of the invention employs enzyme treated protein ingredients included in breadcrumbs or breadcrumb-like products for coating meat or meat-like core before frying as described herein.

### Breadcrumbs

Wheat flour bread is the staple food in many countries and is also used for production of breadcrumbs as a side product. Breadcrumbs are made by drying bread generally at ambient environments, mildly milling, and sieving according to desired particle sizes. Breadcrumbs are used, among others, for coating food before frying to adjust the visual and organoleptic properties, and to prevent moisture loss as well. During reheating too, the crumbs reabsorb liquids with nutrition, including water and oil, and aim at providing appealing textural qualities including crispy external coating and a fried-like flavor. Breadcrumb coating increases the stability of food products, such as fish fingers or onion rings or french-fried potatoes or other fried products like sweet potato or other vegetables.

One of unpleasant features of the crumb-coated products is often their loss of crispiness after freezing and thawing, which poses a problem as heating frozen products in a micro-wave provides different quality than a product that has not been frozen, the crumb layer often having a “mushy” or “muddy” character. Other problems include unstable attachment of the crumb coating to the coated core either before or after frying.

### Breadcrumbs of the Invention

Breadcrumbs for use in accordance with the invention are, according to one embodiment, prepared from dough comprising transglutaminase (TG), and preferably also an additional protein serving as a substrate to TG, said dough being eventually either baked or extruded. According to another embodiment, the breadcrumbs for use in accordance with the invention are obtained by mixing any available breadcrumbs with transglutaminase (TG) and water, and a protein ingredient serving as a substrate to TG, allowing the enzyme to react, followed by redrying. Said protein ingredient may comprise, beside gluten or other proteins comprised in said dough, for example soy proteins or albumins. The products in accordance with the second aspect of the invention comprise a core meat item breadcrumbed with TG-comprising crumbs. The breadcrumbs may be prepared from whole wheat flour or in a mixture with regular and whole wheat flour by any method, including oven baking or extrusion method. When employing the step of leavening, dough is allowed to rise once or more times, and the enzyme is allowed to react with the available proteins. The dough before baking bread preferably comprises several substrates for TG, including proteins from flour and added ingredients. When ready-made breadcrumbs or other breadcrumb-like materials of any type are employed, the breadcrumbs are mixed with a mixture of TG, water, and TG substrates such as albumin or soya proteins, then are allowed to react, for example for 8 hours or less, and are dried to provide “active breadcrumbs” to be used in accordance with the invention. Crumbs for coating the cores of the food products before frying in accordance with the invention may in some embodiments comprise potatoes or other vegetables, said crumbs usually obtained by extrusion. Said core meat item is selected from whole meat, ground meat, cultured meat, plant-based meat, vegetables, or ground vegetables. The textural qualities of the crumb-coated products depend on the morphology of the crumb crust after frying and cooking (porosity, interconnectivity, thickness, and others). The invention improves the desired parameters of the food product by employing TG and said protein ingredient.

Without wishing to be bound by any theory, the inventors believe that the coating layer prepared according to the invention, comprising breadcrumbs or breadcrumb-like materials, for example PVP, affects the liquid transport and ensures such distribution of liquids within the coat and the coated core that usually results in good crispiness, good liquid retention, and other organoleptic features of the fried product, and in some embodiments in better adhesion of the bread coat to the core. Said layer reduces the undesired moisture absorption during the freezing step on one hand, and the undesired juices loss during the heating step (such as in the microwave oven) on the other hand.

### Exemplary Breadcrumbs

White flour containing 10.8% protein (660 g), enzyme TG of BDF company (18 g), albumin (33 g), dry yeast BRAVO (20 g), table salt (15 g), white sugar (15 g), and baking powder (25.5 g) were mixed in a kitchen aid mixer with a dough hook (low speed no. 2) for 150 seconds. Water (450 g) and sunflower oil (10 g) were added and mixed in the mixer with the kneading hook for 10 minutes (low speed no. 4 for 5 minutes and speed no. 6 for 5 more minutes), using a spatula as needed from time to time, thus making a uniform dough, quite thin and not hard, sticking to fingers (like porridge). The dough was left in the mixer bowl, covered with a film, to rise at a temperature of 30-35° C., about 72 percent humidity, for 60 minutes, the dough volume increasing by 70-120%. After removing a dough puff with a spatula, leavening was continued for another hour, and the dough was transferred to a baking pan lined with baking paper, left to rise still more for another hour, covered with cling film (the time of rising dough and the number of rising stages were reduced in some tests). Bread was then baked at 160° C. for about 40 minutes in GIORIK oven. The bread was cooled to room temperature, cut into thin slices and then into cubes, and dried in GIORIK oven at 65-78° C. for 80 minutes with opened chimney, to achieve around 91% dry weight in the cubes. The cubes were ground in a hammer grinder to the breadcrumbs in accordance with the invention. Usually, 90% crumbs had a size between 0.1 and 3.2 mm.

In some embodiments, breadcrumbs are prepared by extrusion of dough, comprising TG that has had a time sufficient for reacting with proteins before said extrusion. The extruder may be for example an experimental extruder model SYSLG30.VI co-rotating twin screw equipped with two-barrel sections, done at optimized conditions of temperature, pressure, and die configuration, the screws being 5.55 cm in diameter and had an overall active length of 50 cm, the extruder operated at 150 and 155 rpm, using a 14.7 KW DC motor to drive the extruder, moisture content of the feed being controlled at 27-30% by injecting water. An adjustable cutter with four blades facing the die may be operated at 300 rpm to cut the extrudate as it emerges from the extruder, extruder temperatures measured by a PC computer being 120° C. for the extruded samples, respectively. Glycerol solution (20%) may be injected into the barrel during extrusion in some cases, the extrudates (pellet) being dried in an oven at 100° C. for 35 min.

Any breadcrumbs or breadcrumb-like materials comprising TG and a protein, such as a plant protein, reacting with TG, may be utilized for breading steaks of meat or meat substitute.

### Exemplary Breaded Steak of Poultry Schnitzel

An example of a product according to the invention is poultry schnitzel coated in crumbs. Chicken breast is dipped in a marinade-brine for the desired period, sometimes only to absorb the marinade in the surface and sometimes overnight, possibly employing a tumbler or rotating drum with or without vacuum to enhance the absorption or brine in the meat, the marinade/brine comprising water, salt, flavors and spices, eggs or egg albumin or a protein reacting with TG, and possibly stabilizers. In some embodiments, excessive liquid is shaken off after marinade/brine treatment. A step of pre-dusting may be employed, which dries the surface of the schnitzel, comprising flour or vegetable powders or breadcrumb materials or rice flour/starch. Said stabilizers may comprise guar gum, locust bean gum, tara gum, carrageenan, starches, or other polysaccharides employed in food industry. Pre-dusted and batter-dipped food item is dredged with the crumbs that are glued to the item by said batter (the batter usually comprising at least water and/or eggs). The coated schnitzel is advantageously fried on oil at about 180° C., usually 20-60 seconds, followed by baking, usually at 160° C., until the item center reaches 74° C. degrees according to the regulations (to destroy eventual pathogens). Another option is to first bake at about 160° C. and then to fry until reaching a desired temperature in the center. Fat absorption may be about 10-15% of the initial weight of meat.

In one rendition, the following materials were mixed in a bowl: 480 g chicken breast, and brine/marinade comprising 400 g water, 2,5 g albumin, 6 g chicken soup, 1 g black pepper, and 2 g crushed garlic. Meat was soaked in the marinade mix at 5° C. for 24 hours and gained 9% weight (480 to 522 g). A 147 g schnitzel marinaded as described above was pre-dusted in finely ground crumbs or flour, dipped in egg batter, and covered with rougher breadcrumbs, gaining 85% weight (147 to 272 g), and fried for 60 seconds, at an initial oil temperature of 182° C. which dropped to 167° C., the temperature in the middle of the schnitzel after frying was 82° C., gaining about 1% weight (272 to 275 g). Another schnitzel, 141 g, was marinaded, pre-dusted, dipped in egg, and covered with breadcrumbs as described above, gaining 90% weight (141 to 268 g), and fried for 45 seconds, at an initial oil temperature of 182° C. which dropped to 166° C., the temperature in the middle of the schnitzel after frying was 68° C., gaining about 1% weight (268 to 270 g). Three other schnitzels, 227 g each, were marinaded, pre-dusted, dipped in egg, and covered with breadcrumbs as described above, gaining 84% weight (227 to 418 g), and baked for 2 minutes at a temperature of about 160° C., the temperature in the middle of the schnitzel after baking was between 80 and 90° C., losing 1.5% weight (414 to 407.5 g). It was found that about 5% crumbs were lost during frying. The schnitzels were crispy after freezing and microwave heating.

### Exemplary Breaded Poultry Meat

The following materials were mixed in a bowl: 500 g chicken wings or legs or breast, 150 g water, 4 g salt, 4 g black pepper, 6 g sweet pepper, 1 g hot chili pepper; meat was soaked in the marinade mix at 5° C. for 12 hours. The meat pieces were taken out from the marinade, dripped, pre-dusted in fine breadcrumbs, soaked in a liquid batter containing TG with albumin, and dusted for example with corn flour and bicarbonate. Said liquid batter containing TG was prepared as follows: 11 g TG enzyme preparation (obtained for example from BDF Company), 25 g albumin, 8 g salt, and 200 g water are mixed well and combined with a mixture of 330 g wheat flour, 50 g corn flower, 10 g sodium bicarbonate, 4 g salt, 4 g black pepper, and 4 g garlic, and 150 g more water is added to the final mix. The meat was fried for the time sufficient for reaching 74° C. in the middle of the meat pieces and frozen; the pieces were crispy after taking from the freezer and microwave heating.

### Exemplary Advantages of the Second Aspect of the Invention

Mixing bread dough or bread-like dough with TG-treated albumin, rising, baking or extruding said dough to obtain bread, and drying and grinding said bread provides breadcrumbs with TG-treated albumin. “Breadcrumbs” for using according to the invention, with TG-treated albumin, may be alternatively obtained by mixing TG-treated albumin with any breadcrumbs or breadcrumb-like materials and with an amount of water, allowing to react, and drying. Said breadcrumb-like material may comprise, for example, rice, quinoa, vegetable-derived starchy material (such as from potatoes), or PVP, and may further comprise an additional protein reacting with TG. Coating steaks with such breadcrumbs provides breaded steaks according to the invention. Breaded steaks in accordance with some preferred embodiments of the invention can be frozen without the unpleasant features often observed in crumb-coated products; the steaks keep their crispiness after freezing and thawing, and even after micro-wave heating without thawing. The steak does not exhibit “mushy” character after freezing and thawing. In some preferred embodiments, the breadcrumb coat is well attached to the core, and the whole product has the desired organoleptic properties, where the core comprises poultry, pork, beef, fish, or vegetable. The loss of liquids from the original steaks is reduced. The juicy character of the coated steak is achieved together with the crispy character of the coat.

### General Notes

Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the appended claims. As used herein the term “about” usually refers to +10%. Specifically, a variety of numerical indicators have been utilized. These numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function. Unless otherwise defined, all technical and scientific terms used herein have the same meaning as commonly understood by one of ordinary skill in the art to which this invention belongs.

1. A food composition comprising meat or meat substitute, and a processed protein ingredient mixed with transglutaminase (TG), wherein said processed protein ingredient comprises less than 15% protein (dry weight).

2. The food composition according to claim 1, wherein said meat comprises an item selected from the group consisting of beef, lamb, pork, poultry, fish, and cultured meat; and/or said meat substitute comprises a vegetable or plant protein product; and/or said processed protein ingredient is derived from plants.

3-4. (canceled)

5. The food composition according to claim 1, comprising:
(a) ground meat;
(b) processed vegetable protein (PVP) comprising less than 15% protein, treated with TG; and
(c) water.

6. The food composition according to claim 5, wherein said ground meat includes at least one member of the group consisting of beef, lamb, pork, and poultry, and wherein said PVP is prepared from at least one member of the group consisting of rice, quinoa, fava, peas, lentils, lupin, peanuts, beans, cereal grains, and legumes.

7. The food composition according to claim 5, further comprising an additional protein reacting with TG.

8. The food composition according to claim 5, exhibiting a fat content of ≤15% on an as is basis and organoleptic properties typical for ground meat products with fat contents higher than 20%.

9. The food composition according to claim 5, wherein said PVP has a protein content of ≤12%.

10. The food composition according to claim 5, exhibiting lower weight loss and shrinkage on heating, even when preceded or followed by a step of freezing, when compared to a composition without PVP and/or TG.

11. A method of manufacturing the food composition of claim 5, comprising:
(a) treating PVP with a TG solution to produce moistened enzyme treated PVP; and
(b) mixing said moistened enzyme treated PVP with ground meat to produce a PVP/ground meat mixture.

12. The method according to claim 11, further comprising adding (i) seasonings and/or spices; and/or (ii) an additional protein which serves as a substrate for TG, being selected from the group consisting of egg proteins, milk proteins, casein, soy proteins, wheat proteins, gluten, collagen, gelatin, albumin, myoglobin, myosin, and actin.

13. (canceled)

14. The method according to claim 11, further comprising (i) shock freezing said PVP/meat mixture; and/or (ii) applying a thermal treatment to said PVP/meat mixture.

15. (canceled)

16. The food composition according to claim 1, comprising:
(a) a steak of meat or meat substitute; and
(b) a processed protein ingredient in mixture with TG comprised in breadcrumbs or breadcrumb-like material coating said steak.

17. The food composition according to claim 16, wherein said steak is selected from the group consisting of beef, lamb, pork, poultry, fish, cultured meat, vegetables, and plant protein products.

18. The food composition according to claim 16, wherein said processed protein ingredient comprises an item selected from the group consisting of soya, wheat, rice, quinoa, fava, peas, lentils, lupin, peanuts, beans, cereal grains, legumes, and processed vegetable protein (PVP).

19. The food composition according to claim 16, further comprising an additional protein reacting with TG.

20. The food composition according to claim 16, being a steak coated with a breadcrumb layer, said layer exhibiting good adhesion to the steak during storage and processing, and/or crispy character after microwave oven heat treatment performed immediately after taking said composition from a freezer.

21. (canceled)

22. A method of manufacturing the food composition of claim 16, comprising:
(a) mixing breadcrumbs or a breadcrumbs-like material, TG, and water, and drying the mixture; or alternatively mixing dough with TG, baking or extruding said dough, drying, and grinding it to obtain breadcrumbs; and
(b) coating said steak with said breadcrumbs or breadcrumb-like material.

23. The method according to claim 22, comprising adding to said breadcrumbs or breadcrumb-like material or to said dough an additional protein which serves as a substrate for TG.

24. (canceled)

25. The food composition according to claim 7, wherein said additional protein reacting with TG is selected from the group consisting of egg proteins, milk proteins, casein, soy proteins, wheat proteins, collagen, gelatin, albumin, myoglobin, myosin, and actin.

26. The food composition according to claim 19, wherein said additional protein reacting with TG is selected from the group consisting of egg proteins, milk proteins, casein, soy proteins, wheat proteins, collagen, gelatin, albumin, myoglobin, myosin, and actin.

27. The method according to claim 23, wherein said additional protein is selected from the group consisting of egg proteins, milk proteins, casein, soy proteins, wheat proteins, collagen, gelatin, albumin, myoglobin, myosin, and actin.
